(19) United States
(12) Patent Application Publication
(10) Pub. No.: US 2019/0019145 A1
(43) Pub. Date: Jan. 17, 2019

(54) SYSTEM AND METHOD FOR PROVIDING ON-DEMAND CARGO TRANSPORTATION SERVICES

(71) Applicant: AUSTIN KIM, FRESH MEADOWS, NY (US)

(72) Inventor: AUSTIN KIM, FRESH MEADOWS, NY (US)

(21) Appl. No.: 15/647,013

(22) Filed: Jul. 11, 2017

(51) Int. Cl. G06Q 10/08; G06Q 40/08; G06Q 10/06

(52) U.S. Cl. CPC G06Q 10/0834; G06Q 10/06315; G06Q 40/08

(57) ABSTRACT

A system for arranging a cargo transportation service includes an interface and a processor. The interface receives a request for cargo transportation service from a customer computing device over a communications network. The request includes a cargo pickup information and a vehicle preference, and a cargo drop off information. The processor selects a transportation vehicle from available cargo transportation vehicles that meets requirements of the request. The processor transmits the cargo pickup information and cargo drop off information to a provider computing device associated with the selected cargo transportation vehicle. The interface receives a cargo pickup notification, a cargo loaded notification, a cargo drop off notification, and a cargo delivery notification from the provider computing device over the communications network.

### FIELD OF THE INVENTION

A cargo/freight transportation system that connects the service providers to users/customers through mobile computing devices. A user can request a cargo/freight transportation vehicle solely for her use or to be shared with other users by operating a mobile computing device.

### FIELD OF THE INVENTION

Currently, consumer can rent a cargo/freight transportation vehicle to be driven by the consumer from a truck renting company. But, they cannot readily rent a pickup truck, cargo van, cutaway van, high cube van, refrigerated truck, straight truck or light duty box truck equipped with a driver and optional number of assistants. That is, they cannot hail a cargo/freight transportation vehicle like they can hail a cab. Accordingly, the claimed invention proceeds upon the desirability of providing a system and method for arranging a cargo transportation service.

### OBJECT AND SUMMARY OF THE INVENTION

In accordance with an exemplary embodiment of the claimed invention, a system determines a dispatch of the cargo transportation vehicle comprises an interface to receive a request for a cargo pickup including a cargo information (e.g., cargo pickup time, cargo only or cargo with number of passengers), cargo pickup location, cargo transportation vehicle requirements (e.g., type of cargo transportation vehicle, size of the vehicle, size of cargo space, share or exclusive cargo transportation vehicle, number of passengers, driver only or driver and number assistants). The system determines the cargo transportation vehicle, including any requested number of assistants, to dispatch to the cargo pickup location, and transmits the cargo pickup information to the provider device associated with the selected cargo transportation vehicle so that the driver can go to the pickup location. Upon arrival of the selected cargo transportation vehicle at the pickup location, the system receives a cargo pickup notification from the provider device associated with the selected cargo transportation vehicle. The system then transmits a cargo drop off location to the provider device associated with selected cargo transportation vehicle.

In accordance with an exemplary embodiment of the claimed invention, a system for arranging a cargo transportation service comprises an interface and a processor. The interface receives a request for cargo transportation service from a customer computing device over a communications network. The customer computing device is uniquely associated with a customer. The request comprises a cargo pickup information comprising at least a cargo pickup location and a type of transportation vehicle preference, and a cargo drop off information comprising at least a cargo drop off location. The processor selects a transportation vehicle from a plurality of available cargo transportation vehicles that meets requirements of the request. The processor transmits the cargo pickup information and cargo drop off information to a provider computing device associated with the selected cargo transportation vehicle via the interface over the communications network. The interface receives a cargo pickup notification from the provider computing device over the communications network, and the cargo pickup notification indicates that the selected transportation vehicle arrived at the cargo pickup location. The interface receives a cargo loaded notification from the provider computing device over the communications network, and the cargo loaded notification indicates that the customer's cargo has been fully loaded onto the selected transportation vehicle. The interface receives a cargo drop off notification from the provider computing device over the communications network, and the cargo destination notification indicates that the selected transportation vehicle arrived at the cargo drop off location. The interface receives a cargo delivery notification from the provider computing device over the communications network, and the cargo delivery notification indicates that the delivery of the customer's cargo has been completed.

In accordance with an exemplary embodiment of the claimed invention, the aforesaid customer computing device comprises a user input device to receive the cargo pickup information and the cargo drop off information.

In accordance with an exemplary embodiment of the claimed invention, the aforesaid cargo pickup information further comprises at least one of a size of a cargo or a cargo space requirement, a type of the cargo, a number of packages in the cargo, a cargo pickup time, a cargo equipment, a cargo loading option, and a type of service.

In accordance with an exemplary embodiment of the claimed invention, the aforesaid type of service comprises a door to door service, a door to room service, a door to curve side service, a room to room service, a room to door service, a room to curve side service, a curve side to curve side service, a curve side to door service, a curve side to room service, a front of building to front of building service, a front of building to inside building service, an inside building to front of building service or an inside building to inside building service.

In accordance with an exemplary embodiment of the claimed invention, the aforesaid cargo pickup information further comprises a number of cargo transportation vehicles by type.

In accordance with an exemplary embodiment of the claimed invention, the aforesaid cargo pickup information further comprises a number of cargo pickups and a number of cargo drop offs, a cargo pickup location for each cargo pickup and a cargo drop off location for each cargo drop off. The processor selects one of the cargo pickup locations that is closest to an initial location of the selected transportation vehicle as the first cargo pickup location.

In accordance with an exemplary embodiment of the claimed invention, the aforesaid cargo information further comprises a number of assistants required in addition to a driver of the selected cargo transportation vehicle to load and unload the cargo. The processor selects the selected transportation vehicle that can accommodate the number of assistants requested in the request.

In accordance with an exemplary embodiment of the claimed invention, the aforesaid cargo information further comprises a number of passengers. The processor selects the selected transportation vehicle that can accommodate the number of passengers in the request.

In accordance with an exemplary embodiment of the claimed invention, the aforesaid processor selects the selected transportation vehicle based on its proximity to the cargo pickup location in response to a determination that multiple transportation vehicles meet the requirements of the request.

In accordance with an exemplary embodiment of the claimed invention, the aforesaid selected transportation vehicle is a pickup truck, cargo van, cutaway van, high cube van, refrigerated truck, straight truck or light duty box truck.

In accordance with an exemplary embodiment of the claimed invention, the aforesaid request further comprises an insurance coverage for transporting a customer's cargo.

In accordance with an exemplary embodiment of the claimed invention, the aforesaid request further comprises an exclusive or a shared use of a transportation vehicle.

In accordance with an exemplary embodiment of the claimed invention, the aforesaid processor determines that the selected transportation vehicle can be shared with a second customer in response to a determination that the selected transportation vehicle can accommodate a combined passenger requirement and a combined cargo space requirement.

In accordance with an exemplary embodiment of the claimed invention, the aforesaid processor determines that the selected transportation vehicle can be shared with a second customer in response to a determination that each customer's vehicle required time under a shared usage does not exceed each customer's vehicle required time under an exclusive usage by more than a predetermined usage time. The vehicle required time for each customer includes a travel time from the cargo pickup location of said each customer to the cargo drop off location of each customer, a loading time to load a cargo of said each customer onto the selected transportation vehicle and an unloading time to unload the cargo of said each customer from the selected transportation vehicle.

In accordance with an exemplary embodiment of the claimed invention, the aforesaid interface receives requests from a plurality of computing devices. The processor determines at least two requests can be served by the selected transportation vehicle in response to a determination that the selected transportation vehicle can accommodate a combined passenger requirement and a combined cargo space requirement of at least two requests.

In accordance with an exemplary embodiment of the claimed invention, the aforesaid interface receives requests from a plurality of computing devices. The processor determines at least two requests can be served by the selected transportation vehicle in response to a determination that a vehicle required time for each request under a shared usage does not exceed a vehicle required time for said each request under an exclusive usage by more than a predetermined usage time. The vehicle required time for each request includes a travel time from the cargo pickup location of said each request to the cargo drop off location of said each request, a loading time to load a cargo of said each request onto the selected transportation vehicle and an unloading time to unload said each customer's cargo from the selected transportation vehicle.

In accordance with an exemplary embodiment of the claimed invention, a computer program product for arranging a cargo transportation service is embodied in a non-transitory computer readable storage medium. The computer program product comprises computer instructions for receiving a request for cargo transportation service from a customer computing device over a communications network. The customer computing device is uniquely associated with a customer. The request comprises a cargo pickup information comprises at least a cargo pickup location and a type of transportation vehicle preference, and a cargo drop off information comprising at least a cargo drop off location. The computer program product comprises computer instructions for selecting a transportation vehicle from a plurality of available cargo transportation vehicles that meets requirements of the request by a processor and transmitting the cargo pickup information and cargo drop off information to a provider computing device associated with the selected cargo transportation vehicle via the interface over the communications network by the processor. The computer program product further comprises computer instructions for receiving a cargo pickup notification from the provider computing device over the communications network, receiving a cargo loaded notification from the provider computing device over the communications network, receiving a cargo drop off notification from the provider computing device over the communications network, and receiving a cargo delivery notification from the provider computing device over the communications network. The cargo pickup notification indicates that the selected transportation vehicle arrived at the cargo pickup location. The cargo loaded notification indicates that the customer's cargo has been fully loaded onto the selected transportation vehicle. The cargo destination notification indicates that the selected transportation vehicle arrived at the cargo drop off location. The cargo delivery notification indicates that the delivery of the customer's cargo has been completed.

In accordance with an exemplary embodiment of the claimed invention a method for arranging a cargo transportation service comprises receiving a request for cargo transportation service from a customer computing device over a communications network. The customer computing device is uniquely associated with a customer. The request comprises a cargo pickup information comprising at least a cargo pickup location and a type of transportation vehicle preference, and a cargo drop off information comprising at least a cargo drop off location. The method comprises selecting a transportation vehicle from a plurality of available cargo transportation vehicles that meets requirements of the request by a processor, and transmitting the cargo pickup information and cargo drop off information to a provider computing device associated with the selected cargo transportation vehicle via the interface over the communications network by the processor. The method further comprises receiving a cargo pickup notification from the provider computing device over the communications network, receiving a cargo loaded notification from the provider computing device over the communications network, receiving a cargo drop off notification from the provider computing device over the communications network, and receiving a cargo delivery notification from the provider computing device over the communications network.

Various other objects, advantages, and features of the claimed invention will become readily apparent from the ensuing detailed description, and the novel features will be particularly pointed out in the appended claims.

### BRIEF DESCRIPTION OF THE DRAWINGS

The present invention is further explained in the description which follows with reference to the drawings, illustrating, by way of non-limiting examples, various embodiments of the invention, with like reference numerals representing similar parts throughout the several views, and wherein:

FIGS. 1-2 are block diagrams of a cargo transportation service system in accordance with an exemplary embodiment of the claimed invention;

FIG. 3 is a block diagram of a mobile customer device in accordance with an exemplary embodiment of the claimed invention;

FIG. 4 is a block diagram of a mobile provider device in accordance with an exemplary embodiment of the claimed invention; and

FIG. 5 is a diagram illustrating the dispatch of cargo transportation vehicle for pickup and delivery of customer's cargo in accordance exemplary embodiment of the claimed invention.

### DETAILED DESCRIPTION

The present invention can be implemented in numerous manner, including as a process, an apparatus, a system and/or a computer program product embodied on a non-transitory computer readable storage medium, and/or a processor configured to execute instructions stored on and/or provided by a memory coupled to the processor. Machines shown or described with figures below provide examples of processing resources and computer-readable mediums on which instructions for implementing the claimed invention can be carried and/or executed. The non-transitory computer-readable mediums include, but are not limited to, permanent memory storage devices, such as hard drives on personal computers or server, portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums.

As used herein, these implementations, or any other form that the invention may take, may be referred to as techniques. In general, the order of the steps of disclosed processes may be altered within the scope of the claimed invention. Unless stated otherwise, a component such as a processor or a memory described as being configured to perform a task may be implemented as a general component that is temporarily configured to perform the task at a given time or a specific component that is manufactured to perform such task. As used herein, the term “processor” refers to one or more devices, circuits, and/or processing cores configured to process data, such as computer program instructions.

In accordance with an exemplary embodiment of the claimed invention, methods, techniques, and actions performed by a computing device are performed programmatically, or as a computer-implemented method. Programmatically, as used herein, means through the use of code or computer-executable instructions. These computer-executable instructions can be stored in one or more memory resources of the computing device. A programmatically performed step may or may not be automatic.

In accordance with an exemplary embodiment of the claimed invention, methods, techniques, and actions performed by a computing device can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

In accordance with an exemplary embodiment of the claimed invention, the computing devices includes processing and memory resources. The computing devices can include, but is not limited to, servers, desktop computers, cellular or smartphones, laptop computers, netbooks, printers, digital picture frames, network equipment, e.g., routers, and tablet devices.

Furthermore, one or more exemplary embodiments described herein may be implemented through the use of instructions that are executable by one or more processors. These instructions may be carried on a computer-readable medium.

As described herein, a customer refers to individuals that are requesting or ordering the cargo/freight transportation service, and a provider and a service provider refers to individuals or entities that can provide the cargo/freight transportation service. Also, as described herein, a user can refer to either the customer or the service provider. For example, a customer can request a cargo/freight transportation vehicle with various conditions and requirements, such as number of hours the vehicle is needed, number of persons in addition to the drive, the size of the vehicle, cargo protective equipment/material, etc., using the system, and a service provider communicates with the system and/or the customer to arrange for the pickup and delivery of the customer's cargo/freight via the service provider's cargo/freight transportation vehicle. Further, as described herein, customer devices and provider devices refer to computing devices that can correspond to desktop computers, cellular or smartphones, laptop computers, netbooks, tablet devices, television (IP Television), etc., that can provide network connectivity and processing resources for enabling a user to communicate with a system over a network.

In accordance with an exemplary embodiment of the claimed invention, if two customers (although described herein for two customers, it can be shared by more than two customers), request a similar cargo transportation vehicle within a predetermined window of cargo pickup time with a similar cargo pickup location and similar cargo drop off locations, then the system offers cargo transportation vehicle sharing option to the two customers or suggest a larger cargo transportation vehicle to accommodate the cargo requirements of the two customers, thereby reducing their individual cost. Two locations that are within a predetermined radius of each other is considered a similar location. The predetermined radius can be arbitrary or can be determined by the operator of the system. If system determined that cargo transportation vehicle requests from different customers can be shared, the system then determines the order of cargo pickups and cargo drop offs to optimize the cargo delivery time and to minimize the wait time. Also, the system transmits the route information for the two customers to the provider device associated with the selected cargo transportation vehicle. If a cargo transportation vehicle has already been assigned to a first customer by the system, and a request for a new cargo transportation service is received by the system from a second customer that can be shared on the already assigned cargo transportation vehicle, then the system provides the customer devices associated with the first and second customers with the option of sharing a cargo transportation vehicle. If the first and second customers already indicated their willingness to share in their cargo transportation vehicle requests or the customer devices associated with the first and second customers transmits acceptance of sharing a cargo transportation vehicle, then the system assigns an appropriate cargo transportation vehicle that meets the requirements both first and second customer. The system then determines the order of cargo pickups and cargo drop offs to optimize the cargo delivery time and to minimize the wait time for both first and second customers. Also, the system transmits the new route information for the first and second customers to the provider device associated with the selected cargo transportation vehicle.

In accordance with an exemplary embodiment of the claimed invention, when customer requests a cargo transportation vehicle using her customer device, the processor executing the application provides an option of requesting exclusive or shared cargo transportation vehicle. If the customer selects an exclusive cargo transportation vehicle, then the system determines a cargo transportation vehicle satisfying the requirements set forth in the customer's request and informs the provider device associated with the selected cargo transportation vehicle of the customer requests. The service provider of the selected cargo transportation vehicle communicates directly with the customer through the application via the customer and provider devices over the communications network. Alternatively, the system can select more one cargo transportation vehicles satisfying the requirements of the customer request, and the customer can select the desired cargo transportation vehicle. The charge for the cargo transportation vehicle can be determined based on multiple factors including, but not limited to, type of a cargo transportation vehicle, number assistants, time, number of passengers, distance traveled and time.

In accordance with an exemplary embodiment of the claimed invention, if the customer selects a shared cargo transportation vehicle, the customer is prompted for a destination address. The system uses the destination address to determine whether a cargo transportation vehicle can be shared with another customer and provides a predetermined discount based on the charge for exclusive use of the cargo transportation vehicle.

In accordance with an exemplary embodiment of the claimed invention, the system determines whether two cargo transportation vehicle requests are similar enough to be served by one cargo transportation vehicle by determining the combined passenger requirements and the combined cargo space requirements, and estimating the vehicle required times (e.g., travel time from the cargo pickup location to the cargo drop off location, cargo loading time and cargo unloading lime) for exclusive use by the first customer and the second customer individually and their individual vehicle required times under shared arrangement. The system determines that the two cargo transportation requests can be combined if each customer's vehicle required time under the shared usage does not exceed each customer's vehicle required time under the exclusive usage by more than a predetermined usage time, e.g., 30 minutes or 1 hour. The predetermined usage time can be determined by the customer, the system operator or vary based on day of the week (weekend vs. week day), time of day, traffic condition, location, type of cargo transportation vehicle, etc.

In accordance with an exemplary embodiment of the claimed invention, position information for each of a plurality of customers and each of a plurality of service providers are determined for a given geographic area. The customers and services providers can be parties for a freight/cargo transportation service. Based, at least in part, on the position information of the customers and the service providers, one or more areas can be determined to have unbalanced supply and demand for cargo/freight transportation service. That is, the system identifies geographical areas where the supply of cargo transportation vehicles exceeds customer service requests or demands by a first threshold (e.g., low demand area), and geographical areas where customer service requests exceeds the supply of cargo transportation vehicles by a second threshold (e.g., low supply area). It is appreciated that the first and second thresholds can be same or different. Information identifying the low demand and low supply areas can be provided to one or more computing devices associated with the service providers to better meet the demands of their potential customers and to better allocated their cargo transportation vehicles. It is appreciated that the service provider can be an operator of one or many cargo transportation vehicles, such as pickup trucks, cargo vans, cutaway vans, high cube vans, refrigerated trucks, straight trucks or light duty box trucks. The service provider can be an individual or an entity, such as a freight or moving company.

The information that identifies low-demand areas and/or low-supply areas can be provided as visualizations that are displayed on one or more computing devices of the service providers. In accordance with an exemplary embodiment of the claimed invention, the visualizations can be provided in conjunction with a map that identifies and distinguishes the low-demand and low-supply areas using different color schemes.

In accordance with an exemplary embodiment of the claimed invention, one or more areas can be also determined to be low-demand or low-supply by the service providers as compared to one or more other areas by forecasting or predicting future demands based on historical data. In this manner, a service provider can, for example, recognize which areas will be likely require additional cargo transportation vehicles, and allocate their cargo transportation vehicles from low-demand areas, thereby enabling the service provider to better balance the supply to the customer demand.

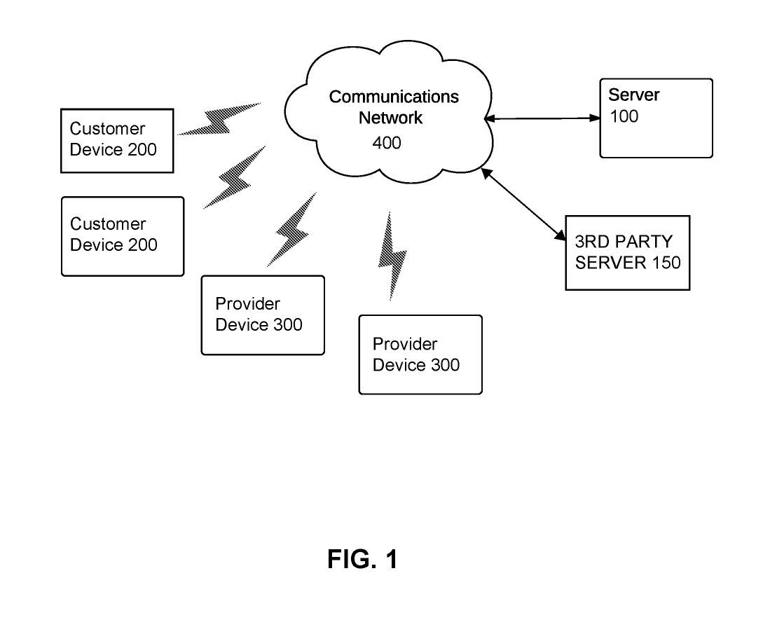

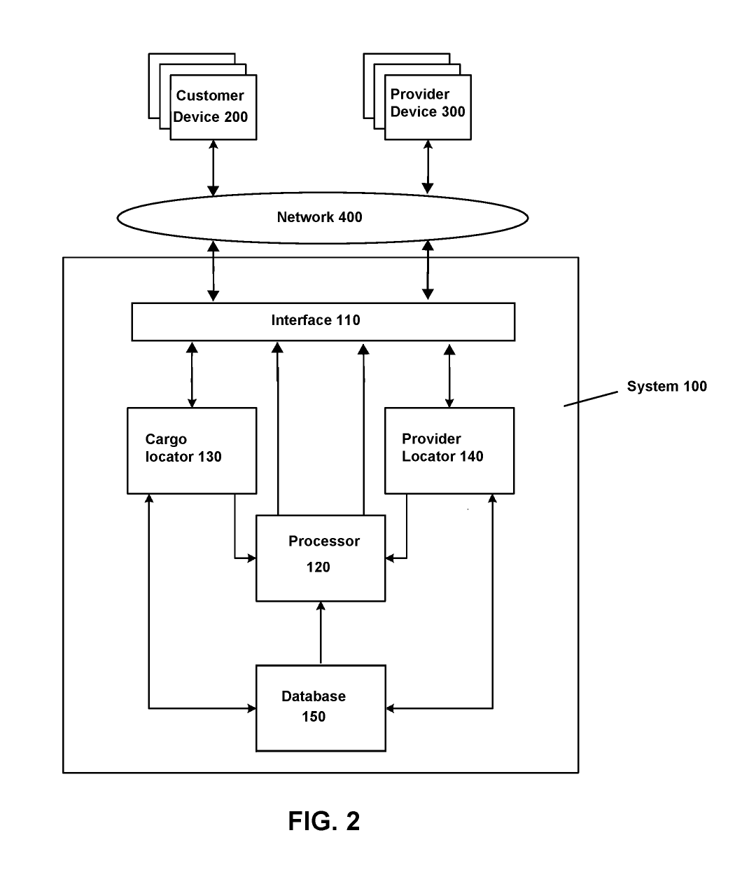

In accordance with an exemplary embodiment of the claimed invention, FIGS. 1 and 2 illustrate a system to provide cargo/freight transportation information to one or more computing devices 200, 300. In accordance with an aspect of the claimed invention, the cargo/freight transportation information can identify areas with low supply of cargo transportation vehicles to assist the service providers in real-time positioning and/or future provisioning of their cargo transportation vehicles. Low-demand and low-supply areas can be determined based, at least in part, on position information received from customer devices 200 and service provider devices 300.

In accordance with an exemplary embodiment of the claimed invention, the system 100 comprises an interface 110, a processor 120, a cargo position locater 130, a provider position locater 140, and one or more databases 150. The database(s) 150 stores data pertaining to customer computing devices 200 and provider computing devices 300, and geographic data for a plurality of geographic areas.

System 100 can operate in connection with a service system, which can enable a cargo/freight transportation service to be arranged between a customer and one or more service providers. Depending on implementation, one or more components of system 100 can be implemented on network side resources, such as on one or more servers. System 100 can also be implemented through other computer systems in alternative architectures (e.g., peer-to-peer networks, etc.).

As an addition or an alternative, some or all of the components of system 100 can be implemented through client applications that operate on the computing devices 200, 300. In accordance with an exemplary embodiment of the claimed invention, a client application can perform one or more of the processes executed by the various components of system 100. System 100 communicates over a network 400, via a wired or wireless network interface 130 to communicate with the one or more computing devices 200, 300.

In accordance with an exemplary embodiment of the claimed invention, the computing devices 200, 300 can individually operate an application, such as an application programming interface (API) that communicates with the interface 130. The API can provide access to system 100 via secure access channels over the network 400 through any number of methods, such as web-based forms, Simple Object Access Protocol (SOAP), remote procedure call (RPC), scripting access, etc., while also providing secure access methods including key-based access to ensure system 100 remains secure and only authorized users and/or third parties can gain access to system 100.

The system 100 receives cargo data from a plurality of customer devices 200 and provider data from a plurality of provider devices 300 via the interface 110 over the network 400. The customer/provider data provides current information about the respective users and/or the respective computing devices 200, 300. In accordance with an exemplary embodiment of the claimed invention, the cargo data can include, but is not limited to, one or more of the following: identification information of the customer or customer device, e.g., customer name, customer ID, phone number, email address, type of cargo, customer's cargo pickup location or the current position information of the customer device 200, e.g., a global positioning system (GPS) data, whether a request is for an immediate or future cargo/freight transportation service, cargo vehicle preference, e.g., a pickup truck, cargo van, cutaway van, high cube van, refrigerated truck, straight truck or light duty box truck, and the service state of the customer. Similarly, in accordance with an exemplary embodiment of the claimed invention, the provider data can include, but is not limited to, one or more of the following: identification information of the service provider or the provider device 300, the current position or GPS information of the provider device 300, the type of service provider's cargo vehicle, the cargo vehicle's availability status, e.g., available, currently in use, out of service.

In accordance with an exemplary embodiment of the claimed invention, the computing 200, 300 transmits the respective cargo data and provider data to the system 100 upon launch of the respective service application via the interface 110 over the network 400. Additionally, the computing device 200, 300 transmits the respective customer/provider data when the user performs certain actions, e.g., the customer requesting a cargo pickup or the service provider responding to the customer service request. Preferably, the system 100 receives customer/provider data, e.g., GPS position, periodically from the computing devices 200, 300.

The cargo data and provider data is received by the respective cargo position locator 130 and the provider position locator 140 via the interface 110. The cargo position locator 130 forwards the cargo data to the database 150 and particular cargo data, e.g., cargo position data, to the processor 120. Similarly, the provider position locator 140 forwards the provider data to the database 150 and particular provider data, e.g., provider position data, to the processor 120. In accordance with an exemplary embodiment of the claimed invention, the cargo position locator 130 uses the cargo data and the geographic data stored in the database 150 to determine the geographic area of the customer cargo and/or the number for customers requesting cargo/freight service within certain geographic area, e.g., Greenwich Village in New York City. Similarly, the provider locator 140 uses the provider data and the geographic data stored in the database 150 to determine the geographic area of the provider's cargo transportation vehicle and/or the number for available cargo transportation vehicles within certain geographic area.

In accordance with an exemplary embodiment of the claimed invention, the processor 120 utilizes the customer position information and the provider position information to determine which geographic areas currently have high or low inventory of available cargo transportation vehicles. The processor 120 utilizes the customer positioning information, the provider positioning information and geographic data to determine the current number of customers and of available cargo transportation vehicles in a given area in New York City, e.g., SoHo in Manhattan.

In accordance with an exemplary embodiment of the claimed invention, the processor 120 provides the determined number of customer and/or available cargo transportation vehicles as a cargo transportation information to the computing devices 200, 300 in a given area via the interface 110 over the network 400. In accordance with an exemplary aspect of the claimed invention, the processor 120 provides the cargo transportation information to only those computing devices 200, 300 that are currently within a predetermined radius of the given geographical area. That is, the processor 120 would not provide cargo transportation information regarding New York City to computing devices 200, 300 located in Dallas, Tex. The cargo transportation information is provided on the display of computing devices 200, 300 within the vicinity of New York City as part of a visualization that overlays or is a part of a map generated by the processor 120 based on the geographic data stored in the database 150. The visualized cargo transportation information is displayed on the provider devices 300 within the vicinity of New York City as a graphic overlay on a map of New York City to provide the locations of customers requesting cargo services. Similarly, the visualized cargo transportation information is displayed on the customer devices 200 within the vicinity of New York City as a graphic overlay on a map of New York City to provide the locations of available cargo transportation vehicles, preferably satisfying the requirements of the respective customers, within the vicinity of New York City.

In accordance with an exemplary embodiment of the claimed invention, the processor 120 generates map to be displayed on the computing devices 200, 300 that provides information regarding the customer's cargo requirements and service provider's cargo transportation vehicles capabilities, e.g., cargo space, type of cargo (such as to haul animals, building materials, plants, home furnishing, industrial equipment, refrigerated, etc.), available cargo equipment (such as blankets, corrugated cardboard). In accordance with an exemplary embodiment of the claimed invention, the processor 120 provides the cargo transportation vehicle type and/or capabilities to the provider locator 140 as part of the provider data. The provider locator 140 determines the number of available cargo transportation vehicles by type and their positions within a given geographic area based on the provider data. Similarly, in accordance with an exemplary embodiment of the claimed invention, the processor 120 provides requested type of cargo transportation vehicles to the cargo locator 130 as part of the cargo data. The cargo locator 130 determines the number of requested cargo transportation vehicles by type and the locations of the customer's cargo within a given geographic area based on the cargo data. The processor 120 generates a map and/or information regarding the available cargo transportation vehicles by type and/or capabilities in the given geographic area to be displayed on the customer device 200, and generates a map and/or information regarding the requested cargo transportation vehicles by type in the given geographic area to be displayed on the provide device 300.

For a given geographic area, the cargo locator 130 determines the position information of the customers requesting cargo transportation vehicles to move their cargos and the provider locator 140 determines the position information of the available cargo transportation vehicles by type. Computing devices 200, 300 corresponding to customers and service providers can communicate with system 100 in order to provide their respective current position information, e.g., GPS data to system 100 via the interface 110 over the network 400.

In accordance with an exemplary embodiment of the claimed invention, the geographic data stored in the database 150 includes map data for different geographic areas. A geographic area can be divided into multiple sub-areas having any shape, geometry, or size. The sub-areas can be identified by an administrator of system 100 and/or by using predetermined information about certain geographic areas, e.g., New York City has five boroughs and each borough has well-known neighborhoods, such as Greenwich village, upper east side, etc. Information of these neighborhoods, boroughs, municipalities and districts are stored as geographic data in the database 150.

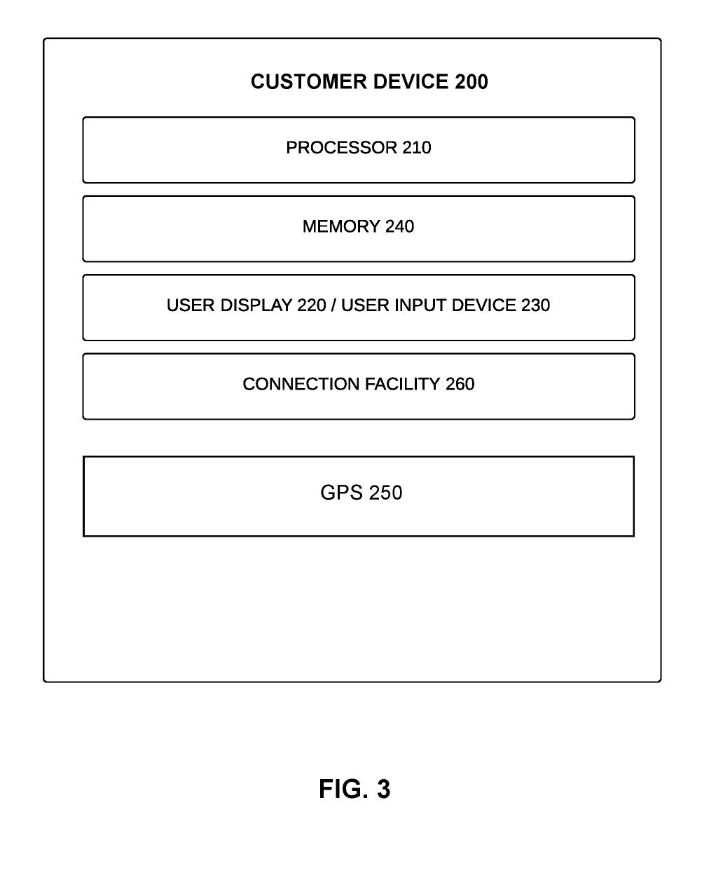

Turning now to FIG. 3, there is illustrated a mobile customer device 200 in accordance with an exemplary embodiment of the claimed invention. In accordance with an exemplar embodiment of the claimed invention, the customer device 200 is a mobile computing device, such as a cellular phone, a smart phone, a tablet, a laptop, a netbook or other portable or non-portable device capable of supporting telephony, messaging and data services. The mobile customer device 200 comprises a processor 210, a display 220, a user input device 230, a GPS or a location detector 250, and a wired and/or wireless connection facility 260. The user input device 230 can include or be part of the touch-sensitive display 220. Preferably, the connection facility 260 can send and receive cellular data over data channels and voice channels.

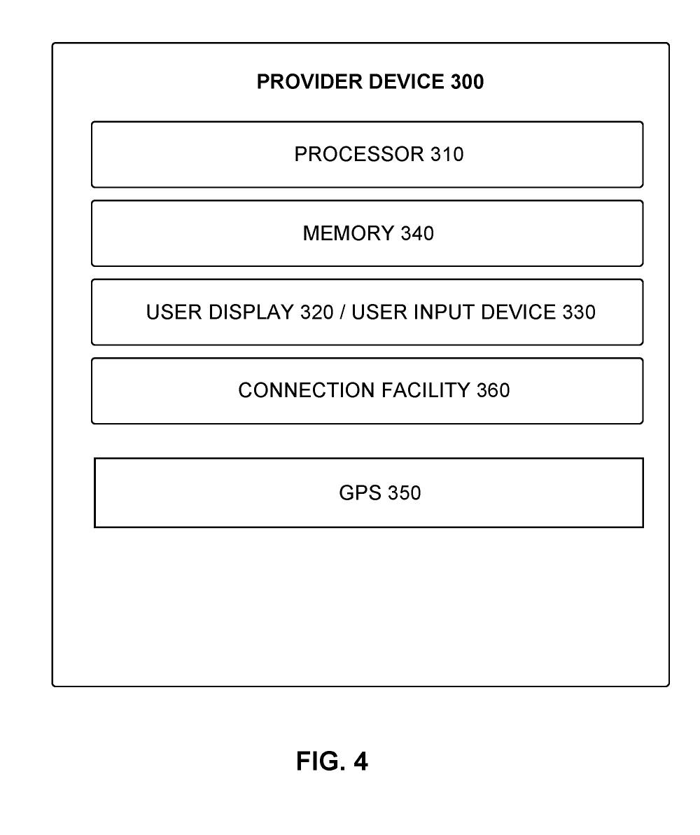

FIG. 4 illustrates a mobile provider device 300 in accordance with an exemplary embodiment of the claimed invention. In accordance with an exemplar embodiment of the claimed invention, the provider device 300 is a mobile computing device, such as a cellular phone, a smart phone, a tablet, a netbook or other handheld device capable of supporting telephony, messaging and data services. The mobile provider device 300 comprises a processor 310, a display 320, a user input device 330, a GPS or a location detector 350, and a wired and/or wireless connection facility 360. The user input device 330 can include or be part of the touch-sensitive display 320. Preferably, the connection facility 360 can send and receive cellular data over data channels and voice channels.

The respective processors 210, 310 provide content to the respective user display 220, 320 by executing instructions and/or applications that are stored in the respective memory 240, 340. In accordance with an exemplary embodiment of the claimed invention, the respective processor 210 310 provides user interface on the respective display 220, 320 to enable to user to operate the respective computing device 200, 300 and communicate with the system.

In accordance with an exemplary embodiment of the claimed invention, the processors 210, 310 are configured with software and/or other logic to perform one or more processes, steps and other functions described herein. The processor 210 is configured with instructions and data stored in the memory 240 and the processor 310 is configured with instructions and data stored in the memory 340, to operate the service applications described herein. For example, a customer can operate the service application of the customer device 200 to instruct the GPS 250 to determine the location data. Similarly, a service provider can operate the service application of the provide device 300 to instruct the GPS 350 to determine the location data. The location data providing the current location of the customer device 200 or the provide device 300. The respective connection facility 260, 360 transmits the location data of the respective computing device 200, 300 to server/system 100.

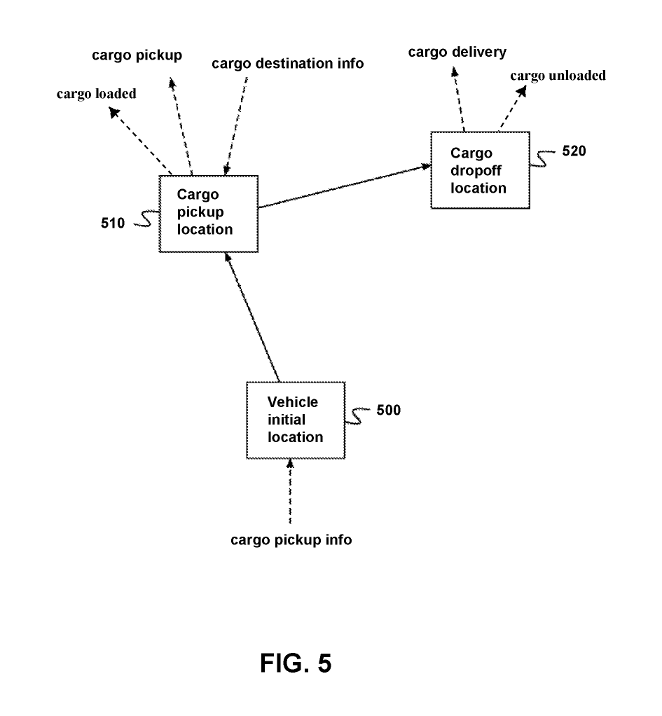

Turning now to FIG. 5, there is illustrate a cargo transportation vehicle making a cargo pickup and drop off for exclusively for one customer in accordance with an exemplary embodiment of the claimed invention. In FIG. 5, the vehicle paths between locations are drawn in solid lines and communications between the system 100 and provider device 300 are drawn in dashed lines. A cargo pickup information is transmitted via the interface 110 over the communications network 400 to the provider device 300 associated with the cargo transportation vehicle selected by the system processor 120 in response to a customer's request for cargo transportation service. The customer requests a cargo transportation service by entering the cargo pickup information and the cargo drop off information on her customer device 200 using the user input device 230. Preferably, the customer processor 210 stores the cargo pickup and drop off information in the memory 240. The customer processor 210 transmits the request comprising both cargo pickup and drop off information to the system via the connection facility 260 over the network. If the cargo pickup location is same as the location of the customer device 210, then the customer processor 210 may transmit the customer location information from the GPS 250 as the cargo pickup location to the system 100. The cargo pickup information comprises at least a cargo pickup location 510, a number of passengers, size and/or type of cargo, number of assistants required to fulfill the customer's cargo transportation service request.

In accordance with an exemplary embodiment of the claimed invention, the system processor 120 transmits available type of service to the customer computing device 200 to be displayed on the user display 220. The available type of service, includes, but is not limited to, a door to door service, a door to room service, a door to curve side service, a room to room service, a room to door service, a room to curve side service, a curve side to curve side service, a curve side to door service, a curve side to room service, a front of building to front of building service, a front of building to inside building service, an inside building to front of building service or an inside building to inside building service.

In accordance with an exemplary embodiment of the claimed invention, the system processor 120 transmits optional insurance coverage information for the type and size of customer's cargo to the customer computing device 200 to be displayed on the user display 220. The customer can decline the insurance coverage or select one of the coverage amount displayed on the user display 220. The insurance coverage can be provided by the service provider or by a third party, i.e., an insurance company. Alternatively, as shown in FIG. 1, the insurance coverage information can be transmitted by a third party server 150 to the customer computing device 200 over the communications network 400.

The provider processor 310 receives the cargo pickup information from the system 100 via the connection facility 360 and displays the cargo pickup information on the user display 320. In accordance with an exemplary embodiment of the claimed invention, the system processor 120 also determines a route based on the initial location 500 of the selected cargo transportation vehicle, cargo pickup location 510, and map/traffic information stored in the database 150. The system processor 120 transmits the route to the provider device 300 via the interface 110 over the network 400. The provider processor 310 receives the route from the system 100 via the connection facility 360, stores the route in the memory 340 and displays the route on the user display 320. Alternatively, the customer processor 210 may determine the route based on the initial location 500 of the selected cargo transportation vehicle, cargo pickup location 510, map/traffic information received from the GPS 350. Upon arrival of the cargo transportation vehicle at the cargo pickup location 510, the provider processor 310 transmits a cargo pickup notification to the customer device 200 associated with the cargo pickup location 510 and/or the system 100 via the connection facility 360 over the network 400. The system 100 may transmit the cargo destination information to the provider device 300 concurrently with the cargo pickup information or upon receipt of the cargo pickup notification. Alternatively, the customer may provide the cargo destination information to the driver of the cargo transportation vehicle, who then enters the information on her provider device 300 via the user input device 330, or the customer processor 210 may transmit the cargo destination information, e.g., cargo drop off location 520, stored in the memory 240 to the provider device 200 via the connection facility 260 over the network 400. The customer's cargo is loaded into the cargo transportation vehicle along with any passenger at the cargo pickup location 510. It is appreciated that the customer's cargo may include one or more items, e.g., a package, multiple boxes, contents of an apartment, etc. Upon completion of the cargo delivery at the cargo drop off location 520, the provider processor 310 transmits a cargo delivery notification to the system 100 via the connection facility 360 over the network 350. Upon receipt of the cargo delivery notification, the system processor 120 deducts the cost of the cargo transportation service from the customer account associated with the customer device 200 or charges the cost of the cargo transportation service to the payment medium, e.g., credit card or debit card, associated with the customer device 200.

In accordance with an exemplary embodiment of the claimed invention, the cargo transportation vehicle can be shared by multiple customers to make multiple pickups and multiple drop offs. The system operation for shared use of the cargo transportation vehicle is similar to the operation for the exclusive use of the cargo transportation vehicle. For simplicity, the system operation for shared use of the cargo transportation vehicle will described for two customers. The system processor 120 transmits first and second cargo pickup information via the interface 110 over the communications network 400 to the provider device 300 associated with the cargo transportation vehicle selected by the system processor 120 in response to first and second customers' requests for shared cargo transportation service. The first and second cargo pickup information comprises at least first and second cargo pickup locations, a number of passengers, size and/or type of cargo, number of assistants required to fulfill the customer's cargo transportation service request. It is appreciated that the system 100 may randomly or designate one of the two cargo pickup locations as the first cargo pickup location based on its proximity to the initial location of the selected cargo transportation vehicle. Similarly, the system 100 may randomly or designate one of the two cargo drop off locations as the first cargo drop off location based on its proximity to the second pickup location. That is, the first pickup location and the first drop off location may not correspond to the same customer.

The provider processor 310 receives the first and second cargo pickup information from the system 100 via the connection facility 360 and displays the first cargo pickup information on the user display 320. The system processor 120 also determines a first route based on the initial location 500 of the selected cargo transportation vehicle, first cargo pickup location, and map/traffic information stored in the database 150. The system processor 120 transmits the first route to the provider device 300 via the interface 110 over the network 400. The provider processor 310 receives the first route from the system 100 via the connection facility 360, stores the first route in the memory 340 and displays the first route on the user display 320. Alternatively, the provider processor 310 may determine the first route based on the initial location of the selected cargo transportation vehicle, the first cargo pickup location, the map/traffic information received from the GPS 350.

Upon arrival of the cargo transportation vehicle at the first cargo pickup location, the provider processor 310 transmits a first cargo pickup notification to the customer device 200 requesting the cargo transportation service from the first cargo pickup location (referred to herein as the first customer for simplicity) and/or the system 100 via the connection facility 360 over the network 400. The system 100 may transmit the first cargo destination information to the provider device 300 concurrently with the first cargo pickup information or upon receipt of the first cargo pickup notification. Alternatively, the first customer may provide the first cargo destination information to the driver of the cargo transportation vehicle, who then enters the information on her provider device 300 via the user input device 330, or the customer processor 210 of the customer device 200 associated with the first customer may transmit the first cargo destination information, e.g., first cargo drop off location, stored in the memory 240 to the provider device 200 via the connection facility 260 over the network 400. The first customer's cargo is loaded into the cargo transportation vehicle along with any passenger at the first cargo pickup location.

Upon transmission of the first cargo pickup notification, the provider processor 310 displays the second cargo pickup information on the user display 320. Upon receipt of the first cargo pickup notification, the system processor 120 determines a second route based on the first cargo pickup location, a second cargo pickup location and map/traffic information stored in the database 150. The system processor 120 transmits the second route to the provider device 300 via the interface 110 over the network 400. The provider processor 310 receives the second route from the system 100 via the connection facility 360, stores the second route in the memory 340 and displays the second route on the user display 320. Alternatively, the provider processor 310 may determine the second route based on the first cargo pickup location, a second pickup location and map/traffic information received from the GPS 350.

Upon arrival of the cargo transportation vehicle at the second cargo pickup location, the provider processor 310 transmits a second cargo pickup notification to the customer device 200 requesting the cargo transportation service from the second cargo pickup location (referred to herein as the second customer for simplicity) and/or the system 100 via the connection facility 360 over the network 400. The system 100 may transmit the second cargo destination information to the provider device 300 concurrently with the second cargo pickup information or upon receipt of the second cargo pickup notification. Alternatively, the second customer may provide the second cargo destination information to the driver of the cargo transportation vehicle, who then enters the information on her provider device 300 via the user input device 330, or the customer processor 210 of the customer device 200 associated with the second customer may transmit the second cargo destination information, e.g., second cargo drop off location 520, stored in the memory 240 to the provider device 200 via the connection facility 260 over the network 400. The second customer's cargo is loaded into the cargo transportation vehicle along with any passenger at the second cargo pickup location.

Upon receipt of the second cargo pickup notification, the system processor 120 determines a third route based on a second cargo pickup location, map/traffic information stored in the database 150 and the cargo drop off location that is closest to the second cargo pickup location. Instead of using the closest cargo drop off location, the system processor 120 may select the third route based the customer's cargo that is easiest to unload first, this may the cargo that was loaded last unto the cargo transportation vehicle. The system processor 120 transmits the third route to the provider device 300 via the interface 110 over the network 400. The provider processor 310 receives the third route from the system 100 via the connection facility 360, stores the third route in the memory 340 and displays the third route on the user display 320. Alternatively, the provider processor 310 may determine the third route based on the second cargo pickup location, map/traffic information received from the GPS 350 and the cargo drop off location that is closest to the second cargo pickup location or cargo that is easiest to unload first.

Upon completion of the cargo delivery at the first selected cargo drop off location, the provider processor 310 transmits a first selected cargo delivery notification to the system 100 via the connection facility 360 over the network 350. Upon receipt of the first selected cargo delivery notification, the system processor 120 deducts the cost of the first selected cargo transportation service from the customer account of the customer device 200 associated with the first selected cargo delivery or charges the cost of the first selected cargo transportation service to the payment medium, e.g., credit card or debit card, associated with the customer device 200 corresponding to the first selected cargo transportation service.

Upon receipt of the first selected cargo delivery notification, the system processor 120 determines a fourth route based on the first selected cargo drop off location, map/traffic information stored in the database 150 and the remaining or second selected cargo drop off location. The system processor 120 transmits the fourth route to the provider device 300 via the interface 110 over the network 400. The provider processor 310 receives the fourth route from the system 100 via the connection facility 360, stores the fourth route in the memory 340 and displays the fourth route on the user display 320. Alternatively, the provider processor 310 may determine the fourth route based on the first selected cargo drop off location, map/traffic information received from the GPS 350 and the second selected cargo drop off location.

Upon completion of the cargo delivery at the second selected cargo drop off location, the provider processor 310 transmits a second selected cargo delivery notification to the system 100 via the connection facility 360 over the network 350. Upon receipt of the second selected cargo delivery notification, the system processor 120 deducts the cost of the second selected cargo transportation service from the customer account of the customer device 200 associated with the second selected cargo delivery or charges the cost of the second selected cargo transportation service to the payment medium, e.g., credit card or debit card, associated with the customer device 200 corresponding to the second selected cargo transportation service.

In accordance with an exemplary embodiment of the claimed invention, the cargo transportation vehicle can be shared by more than two customers, the system processor 120 selects the first or next cargo pickup location and first or next drop off location based on its proximity to the cargo transportation vehicle's current location. That is, next destination for the cargo transportation vehicle is the cargo pickup or drop off location that is closest to the current location of the cargo transportation vehicle. In accordance with an exemplary embodiment of the claimed invention, the order of the cargo pickups and cargo drop-offs is any combination or permutation of the cargo pickups or cargo drop-offs.

In accordance with an exemplary embodiment of the claimed invention, instead of sharing the transportation vehicle with another customer, the customer may have multiple cargo pickup locations and multiple cargo drop off locations. For example, a customer may pick up cargos from several locations for delivery to one drop off location, or pickup multiple cargos from one pickup location for delivery to multiple drop off locations.

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the examples are not limited to those precise descriptions and illustrations. As such, many modifications and variations will be apparent to practitioners. Accordingly, it is contemplated that a particular feature described either individually or as part of an example can be combined with other individually described features, or parts of other examples, even if the other features and examples make no mentioned of the particular feature.

1. A system for arranging a cargo transportation service, comprising:
an interface to receive a request for cargo transportation service from a customer computing device over a communications network, the customer computing device being uniquely associated with a customer, and the request comprising a cargo pickup information comprising at least a cargo pickup location and a type of transportation vehicle preference, and a cargo drop off information comprising at least a cargo drop off location;
a processor to select a transportation vehicle from a plurality of available cargo transportation vehicles that meets requirements of the request, and to transmit the cargo pickup information and cargo drop off information to a provider computing device associated with the selected cargo transportation vehicle via the interface over the communications network;
wherein the interface receives:
a cargo pickup notification from the provider computing device over the communications network, the cargo pickup notification indicating that the selected transportation vehicle arrived at the cargo pickup location;
a cargo loaded notification from the provider computing device over the communications network, the cargo loaded notification indicating that the customer's cargo has been fully loaded onto the selected transportation vehicle;
a cargo drop off notification from the provider computing device over the communications network, the cargo destination notification indicating that the selected transportation vehicle arrived at the cargo drop off location; and
a cargo delivery notification from the provider computing device over the communications network, the cargo delivery notification indicating that the delivery of the customer's cargo has been completed.

2. The system of claim 1, wherein the customer computing device comprises a user input device to receive the cargo pickup information and the cargo drop off information.

3. The system of claim 1, wherein the cargo pickup information further comprises at least one of a size of a cargo or a cargo space requirement, a type of the cargo, a number of packages in the cargo, a cargo pickup time, a cargo equipment, a cargo loading option, and a type of service.

4. The system of claim 3, wherein the type of service comprises a door to door service, a door to room service, a door to curve side service, a room to room service, a room to door service, a room to curve side service, a curve side to curve side service, a curve side to door service, a curve side to room service, a front of building to front of building service, a front of building to inside building service, an inside building to front of building service or an inside building to inside building service.

5. The system of claim 3, wherein the cargo pickup information further comprises a number of cargo transportation vehicles by type.

6. The system of claim 3, wherein the cargo pickup information further comprises a number of cargo pickups and a number of cargo drop offs, a cargo pickup location for each cargo pickup and a cargo drop off location for each cargo drop off; and wherein the processor selects one of the cargo pickup locations that is closest to an initial location of the selected transportation vehicle as the first cargo pickup location.

7. The system of claim 3, wherein the cargo information further comprises a number of assistants required in addition to a driver of the selected cargo transportation vehicle to load and unload the cargo; and wherein the processor selects the selected transportation vehicle that can accommodate the number of assistants requested in the request.

8. The system of claim 3, wherein the cargo information further comprises a number of passengers; and wherein the processor selects the selected transportation vehicle that can accommodate the number of passengers in the request.

9. The system of claim 1, wherein the processor selects the selected transportation vehicle based on its proximity to the cargo pickup location in response to a determination that multiple transportation vehicles meet the requirements of the request.

10. The system of claim 1, wherein the selected transportation vehicle is a pickup truck, cargo van, cutaway van, high cube van, refrigerated truck, straight truck or light duty box truck.

11. The system of claim 1, wherein the request further comprises an insurance coverage for transporting a customer's cargo.

12. The system of claim 1, wherein the request further comprises an exclusive or a shared use of a transportation vehicle.

13. The system of claim 12, wherein the processor determines that the selected transportation vehicle can be shared with a second customer in response to a determination that the selected transportation vehicle can accommodate a combined passenger requirement and a combined cargo space requirement.

14. The system of claim 12, wherein the processor determines that the selected transportation vehicle can be shared with a second customer in response to a determination that each customer's vehicle required time under a shared usage does not exceed said each customer's vehicle required time under an exclusive usage by more than a predetermined usage time, the vehicle required time for each customer includes a travel time from the cargo pickup location of said each customer to the cargo drop off location of said each customer, a loading time to load a cargo of said each customer onto the selected transportation vehicle and an unloading time to unload the cargo of said each customer from the selected transportation vehicle.

15. The system of claim 1, wherein the interface receives requests from a plurality of computing devices; and wherein the processor determines at least two requests can be served by the selected transportation vehicle in response to a determination that the selected transportation vehicle can accommodate a combined passenger requirement and a combined cargo space requirement of said at least two requests.

16. The system of claim 1, wherein the interface receives requests from a plurality of computing devices; and wherein the processor determines at least two requests can be served by the selected transportation vehicle in response to a determination that a vehicle required time for each request under a shared usage does not exceed a vehicle required time for said each request under an exclusive usage by more than a predetermined usage time, the vehicle required time for each request includes a travel time from the cargo pickup location of said each request to the cargo drop off location of said each request, a loading time to load a cargo of said each request onto the selected transportation vehicle and an unloading time to unload said each customer's cargo from the selected transportation vehicle.

17. A method for arranging a cargo transportation service, comprising:
receiving a request for cargo transportation service from a customer computing device over a communications network, the customer computing device being uniquely associated with a customer, and the request comprising a cargo pickup information comprising at least a cargo pickup location and a type of transportation vehicle preference, and a cargo drop off information comprising at least a cargo drop off location;
selecting a transportation vehicle from a plurality of available cargo transportation vehicles that meets requirements of the request by a processor;
transmitting the cargo pickup information and cargo drop off information to a provider computing device associated with the selected cargo transportation vehicle via the interface over the communications network by the processor;
receiving a cargo pickup notification from the provider computing device over the communications network, the cargo pickup notification indicating that the selected transportation vehicle arrived at the cargo pickup location;
receiving a cargo loaded notification from the provider computing device over the communications network, the cargo loaded notification indicating that the customer's cargo has been fully loaded onto the selected transportation vehicle;
receiving a cargo drop off notification from the provider computing device over the communications network, the cargo destination notification indicating that the selected transportation vehicle arrived at the cargo drop off location; and
receiving a cargo delivery notification from the provider computing device over the communications network, the cargo delivery notification indicating that the delivery of the customer's cargo has been completed.

18. A computer program product for arranging a cargo transportation service, the computer program product being embodied in a non-transitory computer readable storage medium and comprising computer instructions for:
receiving a request for cargo transportation service from a customer computing device over a communications network, the customer computing device being uniquely associated with a customer, and the request comprising a cargo pickup information comprising at least a cargo pickup location and a type of transportation vehicle preference, and a cargo drop off information comprising at least a cargo drop off location;
selecting a transportation vehicle from a plurality of available cargo transportation vehicles that meets requirements of the request by a processor;
transmitting the cargo pickup information and cargo drop off information to a provider computing device associated with the selected cargo transportation vehicle via the interface over the communications network by the processor;
receiving a cargo pickup notification from the provider computing device over the communications network, the cargo pickup notification indicating that the selected transportation vehicle arrived at the cargo pickup location;
receiving a cargo loaded notification from the provider computing device over the communications network, the cargo loaded notification indicating that the customer's cargo has been fully loaded onto the selected transportation vehicle;
receiving a cargo drop off notification from the provider computing device over the communications network, the cargo destination notification indicating that the selected transportation vehicle arrived at the cargo drop off location; and
receiving a cargo delivery notification from the provider computing device over the communications network, the cargo delivery notification indicating that the delivery of the customer's cargo has been completed.
